(19) United States
(12) Patent Application Publication
(10) Pub. No.: US 2018/0117530 A1
(43) Pub. Date: May 3, 2018

(54) DEVICE AND METHOD FOR SEPARATING CARBON DIOXIDE FROM A GAS FLOW

(71) Applicant: Siemens Aktiengesellschaft, Munich (DE)

(72) Inventors: Christian Pleißner, Kunreuth (DE); Albert Reichl, Bad Soden (DE); Henning Schramm, Hofheim am Taunus (DE); Gerhard Zimmermann, Höchstadt/Aisch (DE)

(73) Assignee: Siemens Aktiengesellschaft, Munich (DE)

(21) Appl. No.: 15/560,850

(22) PCT Filed: Feb. 10, 2016
(86) PCT No.: PCT/EP2016/052775

§ 371 Date: Sep. 22, 2017

(30) Foreign Application Priority Data
Apr. 2, 2015 (DE) 10 2015 206 050.0

(51) Int. Cl. B01D 53/86; B01D 53/14; B01D 53/18; B01D 53/26; B01D 53/75; C01B 32/50

(52) U.S. Cl. CPC B01D 53/8671; B01D 53/1475; B01D 53/1418; B01D 53/1425; B01D 53/18; B01D 53/261; B01D 2253/112; C01B 32/50; B01D 2252/20494; B01D 2255/1021; B01D 2255/1023; B01D 2257/104; B01D 2255/20761; B01D 53/75

(57) ABSTRACT

A device for separating carbon dioxide from a gas flow, in particular from a flue gas flow, having an absorption unit for separating carbon dioxide from the gas flow using a scrubbing medium, a desorption unit which is fluidically connected to the absorption unit for releasing the absorbed carbon dioxide from the scrubbing medium, and a compressor unit which is connected fluidically downstream of the desorption unit for compressing the released carbon dioxide, the compressor unit being connected fluidically upstream of a cleaning device for the carbon dioxide. A method separates carbon dioxide from a gas flow, in particular from a flue gas flow.

### CROSS REFERENCE TO RELATED APPLICATIONS

This application is the US National Stage of International Application No. PCT/EP2016/052775 filed Feb. 10, 2016, and claims the benefit thereof. The International Application claims the benefit of German Application No. DE 102015206050.0 filed Apr. 2, 2015. All of the applications are incorporated by reference herein in their entirety.

### FIELD OF INVENTION

The invention relates to an apparatus for removing carbon dioxide from a gas stream, more particularly from a flue gas stream. The invention further relates to a method for removing carbon dioxide from a gas stream.

### BACKGROUND OF INVENTION

Against the backdrop of climatic changes, it is a global objective to reduce the emission of pollutants into the atmosphere. This is especially so with regard to the emission of carbon dioxide (CO₂), which accumulates in the atmosphere, hinders radiation of heat away from the Earth, and so leads, in the form of the greenhouse effect, to an increase in terrestrial surface temperature.

Particularly in the case of fossil fuel-fired power stations for generating electrical energy, the combustion of a fossil fuel gives rise to a flue gas containing carbon dioxide. With the aim of avoiding or of reducing emissions of carbon dioxide to the atmosphere, the carbon dioxide must be separated from the flue gas. Accordingly, particularly in the case of existing fossil fuel-fired power stations, suitable measures are being discussed for separating, after combustion, the resultant carbon dioxide from the offgas (post-combustion capture).

As a form of industrial implementation for this purpose, the flue gas after combustion is contacted with a suitable scrubbing medium in an absorption unit or an absorber, and gaseous carbon dioxide present in the flue gas is dissolved in the scrubbing medium and/or absorbed in a chemical sense. The offgas freed from carbon dioxide is lastly discharged into the atmosphere. The scrubbing medium laden with carbon dioxide is fed to a desorption unit or desorber, where the absorbed carbon dioxide is liberated from the scrubbing medium again.

In addition to the carbon dioxide, there are also small amounts of oxygen absorbed in the scrubbing medium within the absorber, this oxygen being liberated again together with the carbon dioxide in the desorber. Depending on the intended further use of the carbon dioxide produced, however, the amount of oxygen present in the carbon dioxide may exceed limiting values stipulated for such use. This is the case, for example, when the carbon dioxide is employed in the context of tertiary petroleum recovery (“enhanced oil recovery”). Accordingly, it becomes necessary for the carbon dioxide liberated in the desorber to be purified in order to remove the oxygen. Common gas purification methods for removing oxygen are the catalytic oxidation of hydrogen (or the catalytic reduction by hydrogen of oxygen that is present in the carbon dioxide), and chemisorption.

In the case of catalytic oxidation, hydrogen in sufficient quantity is admixed to the gas to be purified—in other words, in particular, to the carbon dioxide. In a reactor, charged for example with a noble metal catalyst, the oxygen present in the gas is then reacted with hydrogen to form water. In a cooler downstream of the reactor, the purified gas is cooled and water which has condensed out is removed. The gas purified in this procedure contains less than 5 ppmv (parts per million by volume) of oxygen; the remaining hydrogen content is between 500 ppmv and 1000 ppmv. By including a subsequent drying unit, the water content can be reduced to a level of below 1 ppmv.

In the chemisorption process, the oxygen contained in the gas to be purified is removed over a copper catalyst, for example. When the copper catalyst is laden, it is regenerated by addition of hydrogen. To maximize the uptake capacity of the copper catalyst, the operation is conducted at a temperature of around 200° C. In order to ensure continuous operation, chemisorption requires the use of two reactors. In one reactor in this case the gas is purified, while at the same time the other reactor is being regenerated. The gas is first heated to the required operating temperature, typically employing the heat contained within the gas already purified. On passage of the stream through the copper catalyst, the oxygen present in the gas becomes bound on the copper, and the gas leaves the unit in an oxygen-free condition.

### SUMMARY OF INVENTION

A first problem addressed by the invention is that of specifying an apparatus enabling efficient and cost-effective purification of carbon dioxide as part of a carbon dioxide removal operation.

A second problem addressed by the invention is that of specifying a method which permits correspondingly simple and cost-effective purification of carbon dioxide.

The first problem of the invention is solved in accordance with the invention by an apparatus for removing carbon dioxide from a gas stream, more particularly from a flue gas stream, comprising an absorption unit for separating carbon dioxide from the gas stream by means of a scrubbing medium; a desorption unit connected fluidically to the absorption unit and intended for liberating the absorbed carbon dioxide from the scrubbing medium; and a compressor unit located fluidically downstream of the desorption unit and intended for compressing the liberated carbon dioxide; wherein a purification apparatus for carbon dioxide is located fluidically upstream of the compressor unit.

In a first step, the basis for the invention is the finding that a carbon dioxide stream containing oxygen can in principle be purified at different pressures. Because of the decrease in volume flow associated with increased pressures, purification units smaller in construction are possible at high pressure than at low pressure. The purification of carbon dioxide is therefore customarily performed after a compression stage.

In a second step, the invention acknowledges the comparatively high costs associated with the purification of carbon dioxide at high pressure. Indeed, in the context of “high-pressure operation” of a purification apparatus, the constructional circumstances—such as, for example, the wall thickness of the units and the infeed pressure of the hydrogen—have to be adapted to the elevated pressure conditions. Moreover, more exacting requirements are imposed on the pressure stability and leaktightness of the units respectively employed.

In a third step, contrary to the knowledge about the inherently unwanted increase in volume flow at low pressure, the invention nevertheless considers the possibility of purifying carbon dioxide at low pressure to remove oxygen. The invention, indeed, surprisingly recognizes that in the present context, in spite of constructionally more complex units, a purification apparatus can be integrated more simply and cost-effectively than to date into an above-described removal apparatus if the purification apparatus for carbon dioxide operates at low pressure and consequently is located fluidically upstream of a compressor unit for compressing the purified carbon dioxide.

The flow of carbon dioxide from the desorption unit is fed without compression to the purification apparatus. In that apparatus the oxygen present is removed. Following purification, the carbon dioxide is fed to the compressor unit and compressed. The purification apparatus is located fluidically between the desorption unit and the compressor unit.

This positioning of the purification apparatus, which has not been contemplated before now, allows improvement in the complexity of the method and in the overall costs when constructing and subsequently operating a purification apparatus of this kind, relative to existing apparatus.

The purification apparatus itself need only be designed for low pressures. This means that apparatuses having a low wall thickness can be used, thus reducing the material expenditure and hence the materials costs. Nor is there any need for costly and inconvenient safety technology, like that which is required on operation under high pressures. In other words, the costs arising for the use of constructionally larger apparatus are offset by the advantages which result from a purification apparatus located upstream of the compressor unit.

The carbon dioxide purified to remove oxygen also, of course, meets the requirements in terms of the purity that is required for further use.

To separate off the carbon dioxide present in a gas stream, more particularly in a flue gas stream, the gas stream is conveyed into the absorption unit. Within the absorption unit, the carbon dioxide present in the gas stream is absorbed in a scrubbing medium. The scrubbing medium used is advantageously an amino acid salt solution. An aqueous amino acid salt solution is useful here.

The scrubbing medium laden with carbon dioxide is fed to the desorption unit. For this purpose, the absorption unit is usefully connected fluidically via a discharge line to a feed line of the desorption unit. In the desorption unit, the carbon dioxide absorbed in the scrubbing medium is liberated, and the scrubbing medium freed from carbon dioxide is passed back into the absorption unit, where it is utilized for renewed absorption of carbon dioxide from a flue gas. For this purpose, the desorption unit is advantageously connected fluidically via a return line to a feed line of the absorber.

The carbon dioxide liberated in the desorption unit is taken off at the desorber head and fed to the purification apparatus, where the carbon dioxide is freed of oxygen it contains. Prior to the entry, the oxygen-containing carbon dioxide gas stream advantageously also passes through a condenser, in which water present in the carbon dioxide stream is condensed out. The condenser is usefully located fluidically between the desorption unit and the purification apparatus.

In a further advantageous embodiment of the invention, the purification apparatus is designed for catalytic reduction of the oxygen present in the carbon dioxide. The catalytic reduction of the oxygen is accomplished by reaction of the oxygen present in the carbon dioxide stream with hydrogen over a catalytic surface. It is therefore equally a catalytic oxidation of the hydrogen with oxygen.

The oxygen-containing carbon dioxide stream is fed to the purification apparatus by way of the fluidic communication of the desorption unit with the purification apparatus. For this purpose, a discharge line of the desorption unit usefully communicates with a feed line of the purification apparatus.

For the metering of the hydrogen, a feed line for a hydrogen-containing gas stream is usefully connected to the feed line of the purification apparatus. In this way, the carbon dioxide stream entering the purification apparatus has the requisite amount of hydrogen metered into it. The hydrogen content here is usefully matched to the amount of oxygen.

The catalytic reaction takes place advantageously in a unit of the purification apparatus that is designed accordingly for that purpose. The purification apparatus advantageously comprises a reactor having a catalytically active material. Catalytically active material used is advantageously a noble metal catalyst, such as a platinum catalyst or a palladium catalyst, with the catalytic oxidation of the metered hydrogen (or the catalytic reduction of the oxygen) taking place over the surface of said catalyst, with formation of water.

To remove from the carbon dioxide the water formed in the course of the reaction of oxygen and hydrogen within the reactor, the gas stream is subsequently cooled, and, accordingly, water present in the gas stream and formed by the reaction of the oxygen with hydrogen is condensed out. For this purpose the purification apparatus advantageously comprises a cooler. The cooler is usefully located fluidically downstream of the reactor of the purification apparatus. The water condensed out is then drawn off.

For removing the remaining residual moisture from the carbon dioxide, the purification apparatus advantageously comprises a drying apparatus. The drying apparatus is advantageously designed as an adsorption dryer, which uses corresponding drying agents to withdraw the moisture—that is, in particular, the water—from the carbon dioxide stream. The drying apparatus is usefully located downstream of the cooler.

An alternative embodiment provides for a reactor having an integrated drying apparatus, such that not only a catalyzed reaction of the oxygen with hydrogen but also the drying of the carbon dioxide are performed in a common apparatus.

In one embodiment, the carbon dioxide stream is fed to the compressor unit only after the end of purification, in other words after the catalyzed reaction of the oxygen with hydrogen within the reactor, the subsequent cooling and the condensation of the water formed, and also the removal of the water by drying. For this purpose the purification apparatus usefully communicates fluidically via a discharge line with a feed line of the compressor unit. The compressor unit in this case may be of single-stage or multistage design.

In an alternative embodiment, the invention provides for the use of a purification apparatus which is designed for removing oxygen from the gas stream by means of chemisorption. A purification apparatus of this kind usefully comprises two reactors, in which the oxygen is removed from the carbon dioxide in particular and advantageously by means of a copper catalyst. Purification is accomplished advantageously via the oxidation of the copper catalyst. A purification apparatus of this kind as well is usefully located fluidically between the desorption unit and the compressor unit.

The second problem of the invention is solved in accordance with the invention by a method for removing carbon dioxide from a gas stream, more particularly from a flue gas stream, wherein a gas stream comprising carbon dioxide is fed to an absorption unit, wherein carbon dioxide present in the gas stream is removed therefrom by means of a scrubbing medium, wherein the scrubbing medium laden with carbon dioxide is fed to a desorption unit, wherein the carbon dioxide absorbed in the scrubbing medium is liberated therefrom, and wherein the liberated carbon dioxide prior to compression, in other words in uncompressed form, is fed to a purification apparatus.

Oxygen present in the carbon dioxide is advantageously reduced catalytically in the purification apparatus. For catalytic reduction of the oxygen, a hydrogen-containing gas is usefully metered into the purification apparatus. The catalytic reduction of the oxygen, or catalytic oxidation of the hydrogen metered in, is accomplished by means of a suitable catalytically active material. An advantage is given for this purpose to using a noble metal catalyst, which is charged to a reactor of the purification apparatus.

After the reaction of the hydrogen with the oxygen present in the carbon dioxide stream, water is formed. The water is condensed out advantageously by cooling and is taken off as far as possible. The carbon dioxide purified to remove oxygen is then usefully dried, in order thereby to lower the residual moisture content. The cooled carbon dioxide is subsequently, advantageously, compressed.

Compression of the carbon dioxide stream takes place more particularly only after the oxygen present has been removed, the carbon dioxide stream freed substantially from oxygen has been dried, and the dried carbon dioxide stream has been cooled.

The advantages stated for the dependent claims directed to the apparatus may be transposed mutatis mutandis to the corresponding embodiments of the method.

### BRIEF DESCRIPTION OF THE DRAWINGS

Below, exemplary embodiments of the invention are illustrated with a drawing. In the drawing

FIG. 1 shows an apparatus for removing carbon dioxide from a flue gas stream, with a schematic purification apparatus, and

FIG. 2 shows a purification apparatus suitable for a removal apparatus in accordance with FIG. 1.

### DETAILED DESCRIPTION OF INVENTION

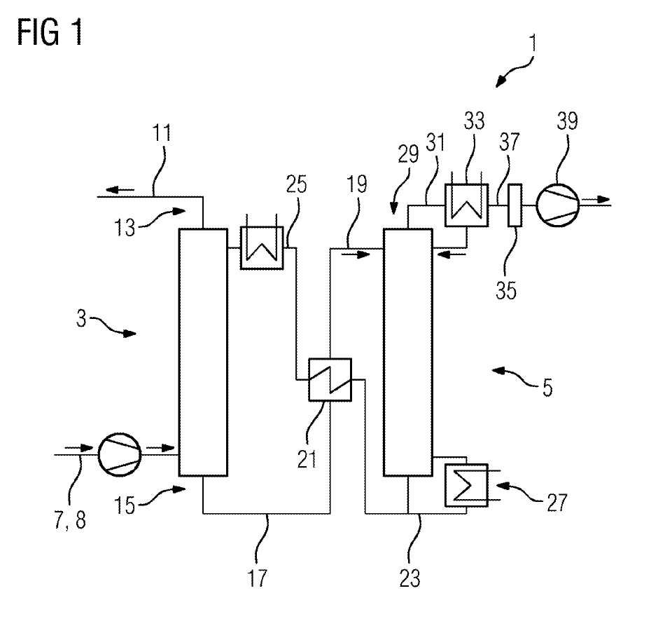

FIG. 1 shows an apparatus 1 for removing carbon dioxide from a flue gas stream. This removal apparatus 1 comprises an absorption unit 3 and a desorption unit 5.

A flue gas 8 for purification flows via a flue gas line 7 into the absorption unit 3. Within the absorption unit 3, the flue gas 8 is contacted with a scrubbing medium 9, and carbon dioxide present in the flue gas 8 is absorbed by the scrubbing medium 9. An aqueous amino acid salt solution is the scrubbing medium 9 used. The purified flue gas is discharged into the atmosphere via a discharge line 11 at the top 13 of the absorption unit 3.

The scrubbing medium 9 laden with carbon dioxide is taken off via a discharge line 17 connected at the bottom 15 of the absorption unit 3. Via a fluidic coupling or communication of the discharge line 17 with a feed line 19 of the desorption unit 5, the laden scrubbing medium 9 is fed to the desorption unit 5. In this case the scrubbing medium 9 passes through a heat exchanger 21.

Within the desorption unit 5, the carbon dioxide is liberated from the scrubbing medium 9 again by thermal desorption. By way of the fluidic communication between a discharge line 23 connected to the desorption unit 5 and a feed line 25 of the absorption unit 3, the scrubbing medium 9, freed from carbon dioxide, is returned to the absorption unit 3, where it is available for renewed absorption of carbon dioxide from a flue gas 8. Connected additionally to the desorption unit 5 is a reboiler 27, which as a bottoms vaporizer supplies part of the regeneration heat for the liberation of the carbon dioxide absorbed in the scrubbing medium 9.

The carbon dioxide released from the scrubbing medium 9 within the desorption unit 5 is taken from said unit at the head 29 of the desorption unit 5, via a discharge line 31 which is connected there, and the carbon dioxide passes through a condenser 33. The carbon dioxide stream also contains small amounts of oxygen, which must be removed from the gas stream. For this purpose, a purification apparatus 35 is located fluidically downstream of the desorption unit 5, and communicates via a feed line 37 with the discharge line 31 of the desorption unit 5.

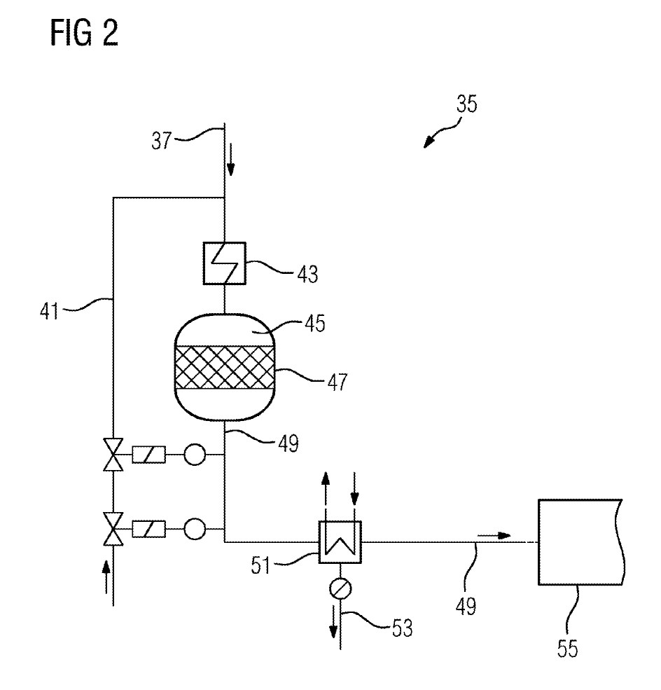

In the purification apparatus 35, the oxygen present in the carbon dioxide is removed. Only after the purification, which is described comprehensively in FIG. 2, is the carbon dioxide fed to a compressor unit 39, where it is compressed.

In other words, the purification apparatus 35 is located fluidically between the desorption unit 3 and the compressor unit 39, and so the carbon dioxide stream leaving the desorption unit 5 is fed in uncompressed form to the purification apparatus 35.

Within the purification apparatus 35, which is shown in FIG. 2, the oxygen present in the carbon dioxide stream is removed. This is accomplished by catalytic reduction of the oxygen present in the carbon dioxide stream, using hydrogen, over a catalytically active surface.

The oxygen-containing carbon dioxide stream is fed to the purification apparatus 35 by way of the fluidic communication of the discharge line 31 of the desorption unit 5 and of the feed line 37 of the purification apparatus 35.

For the metering of the hydrogen, a feed line 41 for a hydrogen-containing gas is connected to the feed line 37 of the purification apparatus 35. After passing through a preheater 43, the hydrogen-containing gas flows together with the oxygen-containing carbon dioxide stream into the reactor 45, which as part of the purification apparatus 35 is located fluidically downstream of the desorption unit 5.

The reactor 45 is charged with a catalytically active material 47. In the present case, platinum meshes are used. The surface of the mesh structure provides the catalytically active surface over which the catalytic oxidation of the hydrogen, or catalytic reduction of the oxygen, takes place. In this process, water is formed, and flows out of the reactor 45 together with the carbon dioxide via a discharge line 49 of said reactor.

Disposed in the discharge line 49 is a cooler 51, in which the water is condensed out and drawn off via a corresponding offtake line 53. For the final drying, the carbon dioxide emerging from the cooler 51 is passed further to a drying apparatus 55, where the water fraction in the carbon dioxide is reduced to below 1 ppmv by adsorption of the water still present.

Only after purification has taken place, in other words after there has been passage through the reactor 45, the cooler 51, and the drying apparatus 55, is the carbon dioxide fed to the compressor unit 39 shown in FIG. 1. For this purpose, the purification apparatus 35 is coupled fluidically via a discharge line 57 to a feed line 59 of the compressor unit 39.

1.-16. (canceled)

17. An apparatus for removing carbon dioxide from a gas stream, comprising:
an absorption unit for separating carbon dioxide from the gas stream by a scrubbing medium;
a desorption unit connected fluidically to the absorption unit and adapted for liberating the absorbed carbon dioxide from the scrubbing medium;
a compressor unit located fluidically downstream of the desorption unit and adapted for compressing the liberated carbon dioxide; and
a purification apparatus for the carbon dioxide, for removing oxygen present in the liberated carbon dioxide, which is located fluidically upstream of the compressor unit.

18. The removal apparatus of claim 17,
wherein the purification apparatus is designed for catalytic reduction of the oxygen present in the carbon dioxide.

19. The removal apparatus of claim 17,
wherein a discharge line of the desorption unit and a feed line for a hydrogen-containing gas are connected to a feed line of the purification apparatus.

20. The removal apparatus of claim 18,
wherein the purification apparatus comprises a reactor having a catalytically active material.

21. The removal apparatus of claim 20,
wherein the purification apparatus comprises a cooler fluidically between the reactor and the compressor unit.

22. The removal apparatus of claim 20,
wherein the purification apparatus comprises a drying apparatus fluidically between the reactor and the compressor unit.

23. A method for removing carbon dioxide from a gas stream, comprising:
feeding a gas stream comprising carbon dioxide to an absorption unit, wherein carbon dioxide present in the gas stream is removed therefrom by a scrubbing medium,
feeding the scrubbing medium laden with carbon dioxide to a desorption unit, wherein the carbon dioxide absorbed in the scrubbing medium is liberated therefrom, and
feeding the liberated carbon dioxide prior to compression to a purification apparatus, wherein oxygen present in the carbon dioxide is removed from the liberated carbon dioxide.

24. The method of claim 23,
wherein oxygen present in the carbon dioxide is reduced catalytically in the purification apparatus.

25. The method of claim 24,
wherein hydrogen is metered into the purification apparatus for catalytic reduction of the oxygen present in the carbon dioxide.

26. The method of claim 24,
wherein the catalytic reduction takes place by a catalytically active material.

27. The method of claim 23,
wherein the carbon dioxide reduced of the oxygen is cooled, and water eliminated in this process is drawn off.

28. The method of claim 27,
wherein the cooled carbon dioxide is dried.

29. The method of claim 28,
wherein the cooled and/or dried carbon dioxide is compressed.

30. The removal apparatus of claim 17,
wherein the gas stream comprises a flue gas stream.

31. The removal apparatus of claim 22,
wherein the purification apparatus comprises a drying apparatus fluidically between the cooler and the compressor unit.

32. The method of claim 23,
wherein the gas stream comprises a flue gas stream.
